(19) United States
(12) Patent Application Publication
(10) Pub. No.: US 2004/0252189 A1
(43) Pub. Date: Dec. 16, 2004

(54) Device for exploration of pipes with centred head

(76) Inventors: Yves Soulabaille, Pierratte (FR); Joel Brun, Saint-Thome (FR)

Correspondence Address: Robert E. Krebs, Thelen Reid & Priest LLP, P.O. Box 640640, San Jose, CA, 95164-0640, US

(21) Appl. No.: 10/870,453

(22) Filed: Jun. 16, 2004

(30) Foreign Application Priority Data
Jun. 16, 2003 (FR) 03 50219

(51) Int. Cl. H04N 7/18

(52) U.S. Cl. 348/84

(57) ABSTRACT

This device enables the use of a projection mobile head (2) and any tools and radiological or physicochemical measurement devices, centred with respect to the pipe to be explored.

It mainly comprises a bundle of ribs (3) placed at the end of the device, around the mobile head (2). The form of the bundle of ribs (3) is adjustable by means of attachment rings (4 and 7) installed free to rotate about the assembly.

Application particularly for exploration and maintenance of ventilation ducts.

### TECHNICAL DOMAIN

The domain of the invention is exploration, inspection, decontamination, maintenance and internal repair of ventilation, air conditioning or other pipes or ducts.

### PRIOR ART AND PROBLEMS THAT ARISE

It is essential to be able to inspect and explore different sorts of pipes, ducts and others that are inaccessible to an operator, in many industrial fields.

It is known how to use more or less robotized instruments inserted inside pipes and controlled from the outside. In particular, there is the “plumbers snake” type inspection device. French patent application 2 768 214 describes such a device for inspection of ventilation ducts or other types of pipes. It includes a mobile head that is inserted inside the duct to be explored. This mobile head may include a video camera connected to external means of displaying and / or recording images inside the duct. The mobile head is also connected to an external compressed air source through a flexible pipe. It also includes means of ejecting air jets towards the walls of the pipe and backwards, to sustain and move the mobile head forwards in the pipe.

This inspection device is incapable of centring itself inside the pipes or ducts being inspected. Furthermore, these characteristics are such that it cannot move for 20 meters or more inside such pipes that include horizontal and vertical parts and elbows and junctions.

The purpose of this invention is to overcome these disadvantages by proposing a centred exploration device.

### SUMMARY OF THE INVENTION

The main purpose of the invention to achieve this purpose is a device for exploration of pipes including a mobile head connected to external control and operating means and a compressed air source, the head comprising at least one compressed gas ejection orifice for propulsion, oriented towards the flexible pipe.

According to the invention, the device is completed by a bundle of ribs placed around the head, which spread out from the other to define a volume for which the maximum perimeter around the longitudinal axis of the assembly is equal to a determined value slightly less than the diameter of the pipe to be explored.

In its main embodiment, the bundle of ribs is centred about the longitudinal axis of the assembly.

In a first embodiment, the mobile head is fixed at the middle of the bundle of ribs.

In a second embodiment, the mobile head is fixed at one end of the bundle of ribs.

It is advantageous if a smooth canula is used between the mobile head and the pipe.

The device according to the invention may be provided with a camera, a brush, a radiological or physicochemical measurement instrument at the head, or it may be completed with a projection device through an orifice such as a nozzle.

In the preferred embodiment of the bundle of ribs according to the invention, the length of the bundle is equal to L, which is 1.5 to 2 times greater than its width.

Preferably, the bundle of ribs is fixed by forward and reverse attachment rings installed free to rotate about the assembly.

### LIST OF FIGURES

The invention and its various embodiments and characteristics will be better understood after reading the following description accompanied by a few figures that in particular represent:

FIG. 1, a first embodiment of the device according to the invention;

FIG. 2, a second embodiment of the device according to the invention; and

FIG. 3, a sectional view of the mobile head of the device according to the invention.

### DETAILED DESCRIPTION OF SEVERAL EMBODIMENTS OF THE INVENTION

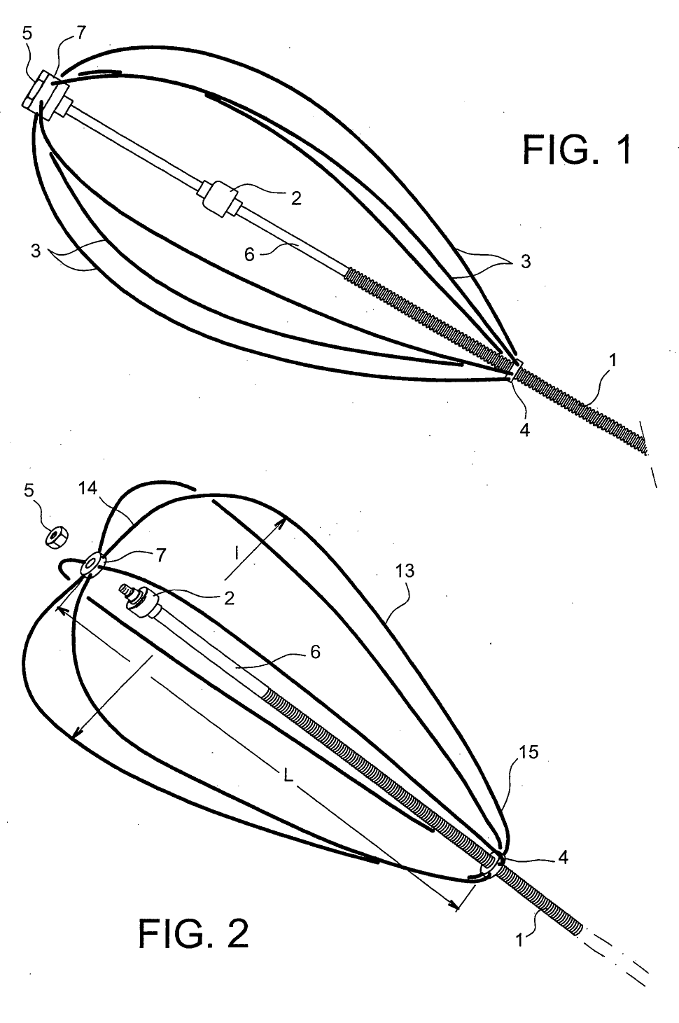

FIG. 1 shows the main part of the exploration device according to the invention, in other words the part related to guidance and to the propulsion head of the invention. It includes mainly a flexible pipe 1 connected to external control and operating means controlled by an operator, outside the pipe to be explored. These means include various facilities including a compressed air source.

The flexible pipe 1 is prolonged by a canula 6 on which the mobile head of the device is placed. The presence of the smooth canula 6 which is approximately 15 cm long, avoids aerodynamic disturbances due to the use of a splined flexible pipe 1. Therefore, this improves thrust parameters by about 10%.

According to the invention, a bundle of ribs 3 in the form of a shell is used. A first end of the ribs 3 is fixed to a rear attachment ring 4 located on the flexible pipe 1. The second end of the ribs 3 is fixed onto a front attachment ring 7, itself fixed to the end of the canula 6.

The rear attachment ring 4 and the front attachment ring 7 are installed free to rotate, to make it easy to handle the assembly. The shape of the shell may be modified by moving the back attachment ring 4 and the front attachment ring 7 further away or closer together such that the distance L separating the rear attachment ring 4 and the front attachment ring 7 is equal to 1.5 to 2 times more than the width 1 of the diameter formed by the bundle of ribs 3. L is equal to 1.5 to 2 times x 1.

In this first embodiment described in FIG. 1, the mobile head 2 is placed in the central region of the bundle formed by the ribs 3. The outside diameter of the bundle of ribs 3 is slightly less than the outside diameter of the duct or the pipe to be explored or treated.

FIG. 2 shows a second form of the shell formed by the bundle of ribs 13. The front part 14 of the ribs is much more curved than the back part 15. Thus, the maximum diameter of the bundle is towards the front of the bundle, so that the mobile head 2 can also be placed towards the front of this bundle on the canula 6.

In the two embodiments shown in FIGS. 1 and 2, it can be understood that the mobile head 2 is globally centred at the middle of the pipe or the duct to be explored.

There are many varied applications. The ventilation ducts may be cleaned or decontaminated, or’ radiological or physicochemical measurements can be carried out on these ducts. In particular, thixotropic gels or foams can be sprayed inside the ventilation ducts.

In both of these two first cases, the exploration device is inserted inside the pipe to be treated, and the mobile head is brought to the furthest point by means of the thrust obtained using compressed air. The ejection orifices in the mobile head 2 face towards the back of the assembly, such that the thrust produced entrains an overall forwards movement.

Gel or foam is projected on the return path of the exploration device, by pulling on the flexible pipe, with the compressed air supplied being cut off. This application means that the overall weight is very low on the forward path, since the gel or foam supply pipe is empty. Thus, the weight of the device is not penalized by the weight of the material to be sprayed during the forward path of the assembly.

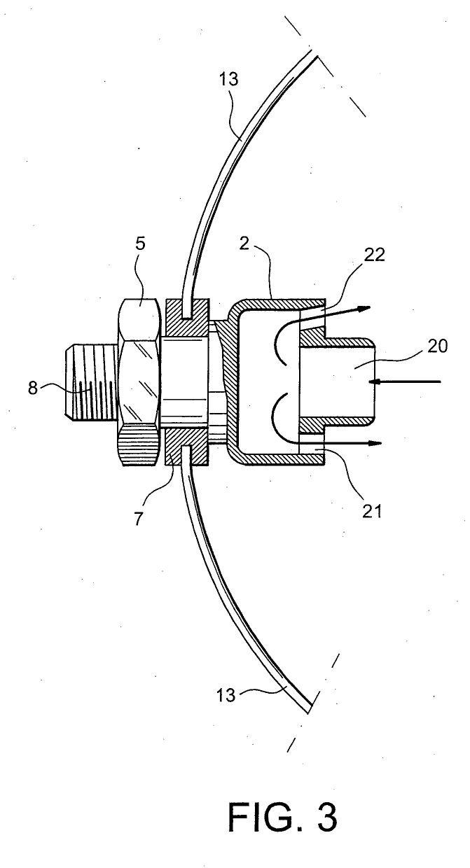

FIG. 3 shows a sectional view of the mobile head 2 of the device according to the invention and its assembly at the end of the device. FIG. 3 shows the mobile head 2, the front attachment ring 7 being fixed by a nut 5 on the threaded attachment rod 8 fixed coaxially to the mobile head 2. Thus, the mobile head is placed in front of the bundle of ribs 13.

Propulsion and orientation of the device are obtained by at least two propulsion orifices 21 and 22 facing backwards, the compressed air arriving through a central orifice 20 in communication with the inside of the canula 6 and the flexible pipe 1 represented in FIGS. 1 and 2. If the orientation of the first orifice 21 is parallel to the axis of the assembly, the second orifice is inclined slightly outwards, preferably by 10° from the longitudinal axis of the assembly. This offset means that the mobile head can be directed inside the pipe, by rotation of the mobile head 2.

Due to the smooth canula 6, the reduction of friction along the pipe or duct to be explored due to the presence of a simple bundle of ribs, provides the means of compensating for the possible use of a stainless steel flexible pipe 1. This is particularly efficient when there is a large number of elbows in the pipe or duct to be inspected. With this type of stainless steel, the device according to the invention can be used in a chemical environment that could be noxious for other exploration devices made of a plastic material.

Finally, the mobile head 2 and the canula 6 are centred using the bundle of ribs, the treatment devices (projection of gel or foam), exploration devices (camera) or radiological or physicochemical measurement devices are also centred in the middle of the pipe or duct in which the device is inserted.

1. Device for exploration of pipes comprising a mobile head (2) connected to external control and operating means and a compressed gas source through a flexible pipe (1) to which the mobile head (2) is fixed, the head comprising at least one compressed gas ejection orifice (21, 22) for propulsion, oriented towards the flexible pipe (1)
characterised in that it comprises a bundle of ribs (3, 13) placed around the mobile head (2), which spread out from the other to define a volume for which the maximum perimeter around the longitudinal axis of the assembly is equal to a determined value slightly less than the diameter of the pipe or the duct to be explored.

2. Device for exploration according to claim 1, characterised in that the bundle of ribs (3, 13) is centred about the longitudinal axis of the assembly.

3. Device for exploration according to claim 1, characterised in that the mobile head (2) is’ fixed at the middle of the bundle of ribs (3).

4. Device for exploration according to claim 1, characterised in that the mobile head (2) is fixed at one front end of the bundle of ribs (13), these ribs being wider on the front part (14) than the rear part (15).

5. Device for exploration according to claim 1, characterised in that it comprises a smooth canula (6) placed between the mobile head (2) and the splined flexible pipe (1)

6. Device for exploration according to claim 1, characterised in that it comprises a camera inside the bundle.

7. Device for exploration according to claim 1, characterised in that the mobile head (2) comprises two ejection orifices, a first orifice (21) parallel to the longitudinal axis of the assembly and a second orifice (22) inclined outwards from the longitudinal axis.

8. Device for exploration according to claim 1, characterised in that the length L of the bundle of ribs (3, 13) is equal to 1.5 to 2 times the bundle diameter 1.

9. Device for exploration according to claim 1, characterised in that the bundle of ribs (3, 13) is installed by means of one rear attachment ring (4) and one front attachment ring (7), installed free to rotate about the assembly.
